(19) United States
(12) Patent Application Publication
(10) Pub. No.: US 2009/0302583 A1
(43) Pub. Date: Dec. 10, 2009

(54) MOTOR VEHICLE PILLAR

(75) Inventor: Sven STEPAN, Gross-Gerau (DE)

Correspondence Address: INGRASSIA FISHER & LORENZ, P.C. (GME), 7010 E. COCHISE ROAD, SCOTTSDALE, AZ, 85253, US

(73) Assignee: GM GLOBAL TECHNOLOGY OPERATIONS, INC., Detroit, MI (US)

(21) Appl. No.: 12/479,405

(22) Filed: Jun. 5, 2009

(30) Foreign Application Priority Data
Jun. 5, 2008 (DE) 102008026817.8

(51) Int. Cl. B60R 21/16

(52) U.S. Cl. 280/728.2

(57) ABSTRACT

A motor vehicle column, in particular an A-, B-, C- or D-column, in which at least one airbag strap is provided, with an inner lining facing the vehicle interior. Several ribs are positioned next to each other on the inner lining.

### CROSS-REFERENCE TO RELATED APPLICATION

This application claims priority to German Patent Application No. 102008026817.8, filed Jun. 5, 2009, which is incorporated herein by reference in its entirety.

### TECHNICAL FIELD

The invention relates to a motor vehicle column, in particular an A-, B-, C- or D-column, in which at least one airbag strap is provided to position an airbag after its deployment, with an inner lining facing the vehicle interior.

### BACKGROUND

Generally known from prior art are so-called head airbags, which deploy on vehicle impact to protect the heads of the vehicle passengers. During deployment of the head airbag, airbag straps, such as retaining and rebound straps, bring the head airbag into a specific position, so that it can optimally serve its purpose. For this reason, it is absolutely essential that the airbag straps, which are often accommodated in the A-, B-, C- or D-pillar, be able to assume their designated position quickly and unimpeded in the event of a collision.

EP 1 419 940 A1 describes a head airbag that is kept in a rail of the vehicle roof for emergency cases. When the head airbag is deployed, an upper area of the inner lining in the roof area of the vehicle is moved so far into the interior as to allow the head airbag to deploy. EP 1 419 940 A1 offers no suggestions with respect to the positioning process of the straps connected with the head airbag.

DE 100 04 483 C2 also discloses no positioning process for the straps connected with the head airbag. DE 100 04 483 C2 describes an airbag arrangement situated in the roof frame area of the motor vehicle so as to absorb energy upon impact of the head of a vehicle passenger against the roof or side lining.

At least one object of the invention is to further develop the generic pillar in such a way that the at least one airbag strap can assume its designated position quickly and unimpeded as the airbag deploys. In addition, other objects, desirable features, and characteristics will become apparent from the subsequent summary and detailed description, and the appended claims, taken in conjunction with the accompanying drawings and this background.

### SUMMARY

The at least one object, other objects, desirable features, and characteristics, are achieved by the invention with a pillar of the kind mentioned at the outset, in which several ribs are positioned next to each other on the inner lining. As the airbag deploys, the airbag strap is moved along, and hence past, the ribs, during which the inner lining is pressed into the vehicle interior, so that the airbag strap moves by the inner lining and can exit the pillar quickly and unimpeded. The airbag strap thereby enables the airbag to deploy as fast as possible over the greatest possible area between the vehicle passengers and the lateral wall of the vehicle interior.

In an embodiment of the invention, a strip can be arranged on the ribs so as to pivot or at least bend away partially. As a result, the airbag strap, which can preferably be a retaining or rebound strap, can impact the strip after having passed the ribs. When the airbag strap impacts the strip, the latter is pivoted or at least bent away partially, so that the airbag strap can exit the pillar.

The strip can be secured to the ribs by a thin attachment web. Since the attachment web is thin, it can exhibit enough flexibility to allow the strip secured thereto to pivot or bend partially away as soon as the airbag strap impacts the strip. The attachment web can best be made of plastic, and sprayed onto the strip and ribs.

In a preferred embodiment, the attachment web can exhibit a concave bend on its surface facing the pillar interior. As a result, the cross section of the attachment web exhibits an area of minimal thickness, which consequently can be easily deformed to pivot or partially bend away the strip, or also serve as a predetermined breaking point.

It is aesthetically pleasing that the strip to exhibit a convex bend on its surface facing the vehicle interior in the area secured to the attachment web. In addition, the convex bend avoids sharp edges, which are undesirable particularly in the vehicle interior.

In order to be able to pivot the strip especially fast upon impact of the airbag strap, the strip can be connected with the ribs by means of a hinge.

The hinge can be a film hinge that can be manufactured especially well out of plastic, and can be sprayed onto the strip and ribs.

To ensure that the airbag strap can reliably impact the strip, it makes sense for the strip to exhibit a certain overhang relative to the ribs. Practice has shown that the overhang should measure at least about six millimeters.

If the side of the ribs facing the at least one airbag strap are inclined, the airbag strap can pass by the ribs along the incline especially well as the airbag deploys, without the chance of it getting snagged by the ribs. This ensures a reliable positioning of the airbag strap.

The ribs can be molded onto the lining as a single piece. Since both the ribs and lining can best be made out of plastic, the ribs can be sprayed onto the lining.

A seal can be applied to the ribs and at least partially cover the strip so as to seal off the interior of the pillar. When the strip is partially covered, the seal can barely be perceived from the vehicle interior, if at all.

The airbag strap can advantageously be secured to a reinforcing plate. This provides the airbag strap with a reliable attachment, which it needs in light of the very high forces that act on the airbag strap during airbag deployment.

### BRIEF DESCRIPTION OF THE DRAWINGS

The present invention will hereinafter be described in conjunction with the following drawing figures, wherein like numerals denote like elements, and:

FIG. 1 is a side view of an A- and A2-pillar; and

FIG. 2 is a sectional view through the A2-pillar from FIG. 1.

### DETAILED DESCRIPTION

The following detailed description is merely exemplary in nature and is not intended to limit application and uses. Furthermore, there is no intention to be bound by any theory presented in the preceding background or the following detailed description.

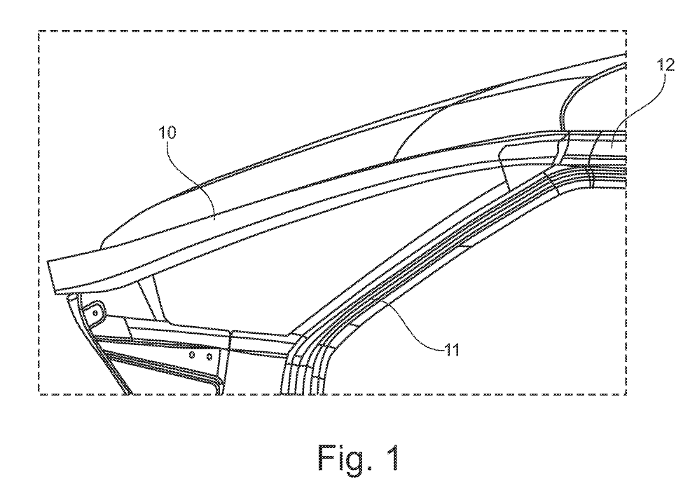

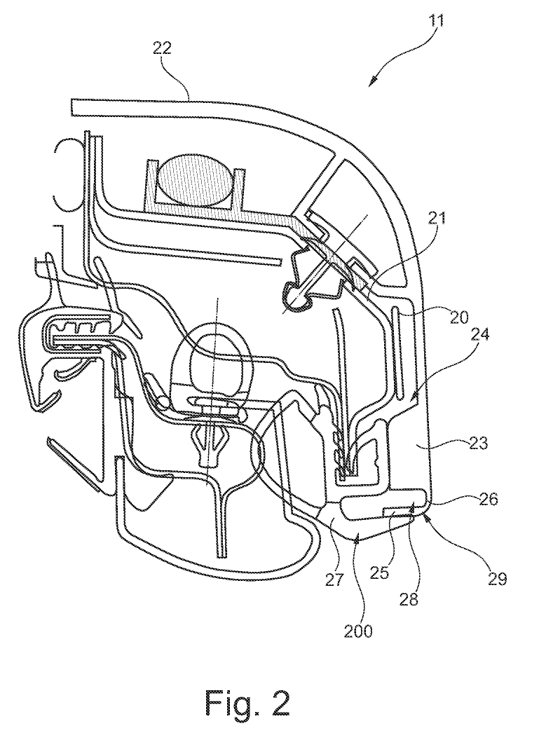

FIG. 1 presents an A-pillar 10 and an A2-pillar 11 of a motor vehicle (not shown in any greater detail here). The A2-pillar 11 incorporates an airbag strap 20 (see FIG. 2), which is secured to an airbag that is not shown in any greater detail here and accommodated in a partially depicted vehicle roof 12.

The airbag strap 20 is secured to a reinforcing plate 21 inside the A2-pillar 11. The A2-pillar is covered by an inner lining 22 relative to a vehicle interior (not shown in any greater detail here).

Ribs 23 are arranged next to each other on the inner lining 22 along the A2-pillar 11, wherein only one rib 23 is visible in the selected representation, covering the ribs adjacent to it. The ribs 23 exhibit an inclination 24.

Provided underneath the ribs 23 is a strip 25 secured to the ribs 23 by an attachment web 26. A seal is applied to the ribs 23 and strip 25, wherein the seal 27 at least partially covers the strip 25.

When the airbag not visible here is deployed during an accident, the airbag strap 20 must be able to exit the A2-pillar. The airbag strap 20 is then guided over the inclination 24, and subsequently pulled between the ribs 23 and seal 27. The airbag strap 20 here presses the inner lining 22 in the area of the ribs 23 to the right and into the vehicle interior. After the airbag strap 20 has passed by the ribs 23, it impacts the strip 25, so that the latter is pivoted or at least bent partially away in the area of the airbag strap 20. In this way, the airbag strap 20 can rapidly exit the A2-pillar to bring the airbag into its position.

The cross section of the attachment web 26 exhibits less of a thickness than the inner lining 22, so that the strip 25 can be easily pivoted or at least partially bent away to the right.

The attachment web 26 has a concave bend 28, so that its cross section in the middle between the ribs 23 and strip 25 exhibits an area of minimal thickness, which can be easily deformed for pivoting or at least partially bending away the strip 25.

The area of the strip 25 secured to the attachment web 26 is provided with a convex bend 29, thereby avoiding sharp edges and creating an aesthetically pleasing design.

The strip 25 exhibits an overhang 200 relative to the ribs 23, which ensures that the airbag strap 20 reliably impacts the strip 25 or overhang 200 after passing by the ribs 23.

While at least one exemplary embodiment has been presented in the foregoing summary and detailed description, it should be appreciated that a vast number of variations exist. It should also be appreciated that the exemplary embodiment or exemplary embodiments are only examples, and are not intended to limit the scope, applicability, or configuration in any way. Rather, the foregoing summary and detailed description will provide those skilled in the art with a convenient road map for implementing an exemplary embodiment, it being understood that various changes may be made in the function and arrangement of elements described in an exemplary embodiment without departing from the scope as set forth in the appended claims and their legal equivalents.

What is claimed is:

1. A pillar of a motor vehicle, comprising:
an airbag;
an airbag strap adapted to position the airbag after a deployment;
an inner lining of the airbag strap that faces an interior of the motor vehicle; and
a plurality of ribs positioned next to each other on the inner lining.

2. The pillar according to claim 1, wherein a strip is arranged on the plurality of ribs so as to at least bend away partially.

3. The pillar according to claim 2, wherein the strip is secured to the plurality of ribs by an attachment web.

4. The pillar according to claim 3, wherein the attachment web is adapted to exhibit a concave bend on a surface facing an interior of the pillar.

5. The pillar according to claim 3, wherein the strip is adapted to exhibit a convex bend on a surface facing the interior of the motor vehicle in an area secured to the attachment web.

6. The pillar according to claim 2, wherein the strip is connected with the plurality of ribs with a hinge.

7. The pillar according to claim 6, wherein the hinge is a film hinge.

8. The pillar according to claim 2, wherein the strip is adapted to exhibit an overhang relative to the plurality of ribs.

9. The pillar according to claim 1, wherein the plurality of ribs is adapted to exhibit an incline on a side facing the airbag strap.

10. The pillar according to claim 1, wherein the plurality of ribs are molded onto the inner lining as a single piece.

11. The pillar according to claim 2, further comprising a seal that is applied to the plurality of ribs and at least partially covers the strip.

12. The pillar according to claim 1, wherein the airbag strap is secured to a reinforcing plate.
